(19) United States
(12) Patent Application Publication
(10) Pub. No.: US 2025/0070641 A1
(43) Pub. Date: Feb. 27, 2025

(54) POWER CONVERSION CIRCUIT AND METHOD

(71) Applicant: SG MICRO CORP, Beijing (CN)

(72) Inventors: Lei Tan, Beijing (CN); Lijun Liu, Beijing (CN)

(21) Appl. No.: 18/707,974

(22) PCT Filed: Aug. 18, 2022
(86) PCT No.: PCT/CN2022/113209

§ 371 Date: May 7, 2024

(30) Foreign Application Priority Data
Dec. 31, 2021 (CN) 202111664004.6

(51) Int. Cl. H02M 1/00; H02M 1/32; H02M 3/07; H02M 7/217

(52) U.S. Cl. CPC H02M 1/0095; H02M 1/32; H02M 3/07; H02M 7/217

(57) ABSTRACT

The present disclosure provides a power conversion circuit and a power conversion method. The power conversion circuit includes: a flying capacitor; an energy storage capacitor; and a rectifier configured to turn on a charge path through which the flying capacitor is charged by the AC input voltage or a transfer path from the flying capacitor to the energy storage capacitor selectively according to a direction of the AC input voltage, so as to provide the DC output voltage across ends of the energy storage capacitor, wherein the rectifier is further configured to stabilize the DC output voltage within a set range by controlling a discharge path of the flying capacitor to ground. Compared with conventional AC-DC converters, no high-voltage device and other rectifying circuit is needed in the power conversion circuit of the present disclosure, so as to reduce structure complexity and cost of the circuit greatly.

### CROSS-REFERENCE TO RELATED APPLICATION

This application is a Section 371 National Stage application of International application NO. PCT/CN2022/113209, which was filed on Aug. 18, 2022 and published as WO/2023/124117A1 on Jul. 6, 2023, and claims priority to the Chinese Patent Application No. 202111664004.6, filed on Dec. 31, 2021, entitled “power conversion circuit and method”, the contents of which are incorporated herein by reference in their entireties.

### FIELD OF TECHNOLOGY

The present disclosure relates to a technical field of power conversion, and in particular, to a power conversion circuit and a power conversion method.

### DESCRIPTION OF THE RELATED ART

Power conversion circuits have been widely used in electronic systems for generating operating voltages and currents required by internal circuit modules or loads. A power conversion circuit includes a DC-DC converter and an AC-DC converter, the AC-DC converter is used for converting an AC voltage into a constant DC signal (e.g., a DC voltage or a DC current).

An auxiliary power supply is a power supply that works prior to a system and can supply power to a control part and a monitor part of a main system with relatively low power. Conventional auxiliary power supplies mostly adopt a resistor current-limiting buck, a capacitor voltage-dividing buck or the AC-DC converter with a small size to achieve power conversion with complex circuit structure, high power consumption and high cost. With the emergence of a large number of auto-sensing startup devices, the use of auxiliary power supplies is increasing, and therefore the power consumption and cost of auxiliary power supplies become important factors affecting an efficiency of devices.

### SUMMARY OF THE DISCLOSURE

In view of the above problems, an objective of the present disclosure is to provide a power conversion circuit and a power conversion method with high efficiency and low cost.

According to an aspect of embodiments of the present disclosure, there is provided a power conversion circuit used for converting an AC (alternating current) input voltage to a DC (direct current) output voltage, and the power conversion circuit includes: a flying capacitor: an energy storage capacitor; and a rectifier configured to turn on a charge path through which the flying capacitor is charged by the AC input voltage, or a transfer path from the flying capacitor to the energy storage capacitor selectively according to a direction of the AC input voltage, so as to provide the DC output voltage across ends of the energy storage capacitor, wherein the rectifier is further configured to stabilize the DC output voltage within a set range by controlling a discharge path of the flying capacitor to ground.

Optionally, in a case that the AC input voltage is a negative voltage, the rectifier couples the flying capacitor between two ends of an AC power supply and charges the flying capacitor by the AC power supply, in a case that the AC input voltage is a positive voltage, the rectifier couples the flying capacitor and the energy storage capacitor in series between two ends of the AC power supply and charges the energy storage capacitor by the flying capacitor.

Optionally, the rectifier is configured to control the discharge path of the flying capacitor to ground according to a charging voltage level of the energy storage capacitor.

Optionally, the rectifier includes: a rectifying element connected between the flying capacitor and the energy storage capacitor: and a switching element connected between the flying capacitor and a second end of said AC power supply.

Optionally, in a case that the AC input voltage is the positive voltage and the switching element is in an off state, the flying capacitor transfers energy to the energy storage capacitor, in a case that the AC input voltage is the positive voltage and the switching element is in an on state, the flying capacitor discharges to ground through the switching element.

Optionally, the rectifier further includes: a comparator, configured to control the switching element to be on and off according to a voltage on the energy storage capacitor. Optionally, the comparator is a hysteresis comparator.

Optionally, the switching element includes a field effect transistor.

Optionally, the rectifying element includes a diode or a field effect transistor.

Optionally, the power conversion circuit further includes a voltage monitoring

circuit, wherein the voltage monitoring circuit is configured to maintain the DC output voltage within a predetermined range.

Optionally, the voltage monitoring circuit includes: one or a combination of some of an overvoltage protection circuit, an under-voltage protection circuit, a voltage regulator and a DC-DC converter.

Optionally, the DC-DC converter includes a topology selected form a group consisting of Buck-type, Boost-type, Buck-Boost-type, non-inverting Buck-Boost-type, forward-type, flyback-type topologies.

According to another aspect of embodiments of the present disclosure, there is provided a power conversion method used for converting an AC input voltage to a DC output voltage, and the power conversion method includes: setting a flying capacitor and an energy storage capacitor: turning on a charge path through which the flying capacitor is charged by the AC input voltage or a transfer path from the flying capacitor to the energy storage capacitor selectively according to a direction of the AC input voltage, so as to provide the DC output voltage across ends of the energy storage capacitor: and stabilizing the DC output voltage within a set range by controlling a discharge path of the flying capacitor to ground.

Optionally, turning on a charge path through which the flying capacitor is charged by the AC input voltage or a transfer path from the flying capacitor to the energy storage capacitor selectively according to a direction of the AC input voltage includes: coupling the flying capacitor between two ends of an AC power supply and charging the flying capacitor by the AC power supply in a case that the AC input voltage is a negative voltage, coupling the flying capacitor and the energy storage capacitor in series between two ends of the AC power supply and charging the energy storage capacitor by the flying capacitor in a case that the AC input voltage is a positive voltage.

Optionally, stabilizing the DC output voltage within a set range by controlling a discharge path of the flying capacitor to ground includes: controlling the discharge path of the flying capacitor to ground according to a charging voltage level of the energy storage capacitor.

Optionally, the power conversion method further includes: arranging a rectifying element between the flying capacitor and the energy storage capacitor; and arranging a switching element between the flying capacitor and a second end of said AC power supply: wherein, in a case that the AC input voltage is the positive voltage and the switching element is in an off state, the flying capacitor transfers energy to the energy storage capacitor, in a case that the AC input voltage is the positive voltage and the switching element is in an on state, the flying capacitor discharges to ground through the switching element.

Optionally, controlling the discharge path of the flying capacitor to ground according to a charging voltage level of the energy storage capacitor includes: setting a comparator configured to control the switching element to be on and off according to a voltage on the energy storage capacitor.

Optionally, the comparator is a hysteresis comparator.

Optionally, the switching element includes a field effect transistor.

Optionally, the rectifying element includes a diode or a field effect transistor.

Optionally, the power conversion method further includes: setting a voltage monitoring circuit, wherein the voltage monitoring circuit is configured to maintain the DC output voltage within a predetermined range.

Optionally, the voltage monitoring circuit includes: one or a combination of some of an overvoltage protection circuit, an under-voltage protection circuit, a voltage regulator and a DC-DC converter.

Optionally, the DC-DC converter includes a topology selected form a group consisting of Buck-type, Boost-type, Buck-Boost-type, non-inverting Buck-Boost-type, forward-type, flyback-type topologies.

In summary, the present disclosure provides a power conversion circuit using a charge pump to achieve rectification and including the flying capacitor, the energy storage capacitor, and the rectifier. The rectifier turns on the charge path through which the flying capacitor is charged by the AC input voltage or the transfer path from the flying capacitor to the energy storage capacitor selectively according to the direction of the AC input voltage, so that the DC output voltage can be provided across the ends of the energy storage capacitor, and a number of times to transfer charge in the charge pump is controlled by controlling the discharge path to achieve stable control of the output voltage. Compared with conventional AC-DC converters, no high-voltage device and other rectifying circuit is needed in the power conversion circuit of the present disclosure, so as to reduce structure complexity and cost of the circuit greatly. Further, the power conversion circuit of the present disclosure has an extremely low loss, so that the power conversion circuit of the present disclosure is significantly superior to conventional AC-DC converters, both in terms of hardware cost and usage cost.

### BRIEF DESCRIPTION OF THE DRAWINGS

Through the following description of the embodiments of the present disclosure with reference to the accompanying drawings, the above and other objectives, features, and advantages of the present disclosure will be more apparent.

FIG. 1 shows a schematic circuit diagram of a power conversion circuit according to a first embodiment of the present disclosure:

FIG. 2 shows a schematic circuit diagram of a power conversion circuit according to a second embodiment of the present disclosure:

FIG. 3 shows a schematic circuit diagram of a power conversion circuit according to a third embodiment of the present disclosure.

### DETAILED DESCRIPTION OF THE DISCLOSURE

The present disclosure will be described in greater detail below with reference to the accompanying drawings. In the various accompanying drawings, the same elements are represented using similar symbols. For clarity, portions of the accompanying drawings are not drawn to scale. In addition, certain well-known portions may not be shown in the drawings.

Many particular details of the present disclosure, such as the construction, materials, dimensions, treatment processes, and techniques of the components, are described below for a clearer understanding of the present disclosure. However, as those skilled in the art can appreciate, the present disclosure may be realized without following these particular details.

It is to be understood that in the following description, “circuit” may include single or multiple combinations of hardware circuits, programmable circuits, state machine circuits, and/or elements capable of storing instructions that are executed by the programmable circuits. When an element/circuit is said to be “connected to” or “coupled to” another component, or a component/circuit is said to be “connected between” or “coupled between” two nodes, it may be directly coupled or connected to the other element or there may be an intermediate element between the two, and the connection or coupling between the elements may be physical, logical, or a combination thereof. Conversely, when an element is said to be “directly coupled to” or “directly connected to” to another element, it means that there is no intermediate element between the two.

In the present application, when a transistor is “in off state” or “off”, the transistor blocks current and/or conducts essentially no current. In contrast, when the transistor is “in on state” or “on”, the transistor is able to conduct current significantly. For example, in one embodiment, the transistor includes an N-channel metal-oxide-semiconductor (NMOS) field-effect transistor (FET), wherein a voltage is provided between a first end (i.e., drain) and a second end (i.e., source) of the transistor. In some embodiments, an integrated controller circuit may be used to drive a power switch when regulating an energy provided to a load. Furthermore, for the purposes of this disclosure, “ground” or “ground potential” in this application refers to a reference voltage or potential, and relative to which all other voltages or potentials of the electronic circuit or integrated circuit (IC) are defined or measured.

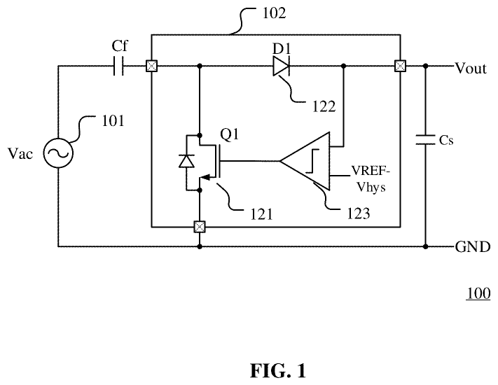

FIG. 1 shows a schematic circuit diagram of a power conversion circuit according to a first embodiment of the present disclosure. As shown in FIG. 1, the power conversion circuit 100 includes an AC power supply 101, a flying capacitor Cf (also referred to a flying capacitor), an energy storage capacitor Cs, and a rectifier 102, wherein the AC power supply 101 is configured to provide an AC input voltage Vac. A first end of the flying capacitor Cf is coupled to a first end of the AC power supply 101, and a second end of the flying capacitor Cf is coupled to the rectifier 102. The rectifier 102 includes an input terminal, an output terminal and a ground terminal. The input terminal of the rectifier 102 is coupled to the second end of the flying capacitor Cf. The output terminal of the rectifier 102 is coupled to a first end of the energy storage capacitor Cs. The ground terminal of the rectifier 102 is coupled to a second end of the AC power supply 101 and ground GND. A second end of the energy storage capacitor Cs is also coupled to ground GND. The rectifier 102 is configured to turn on a charge path through which the flying capacitor Cf is charged by the AC input voltage or a transfer path from the flying capacitor Cf to the energy storage capacitor Cs selectively according to a direction of the AC input voltage Vac, so as to provide a DC output voltage Vout across ends of the energy storage capacitor Cs. Further, the rectifier 102 is also configured to stabilize the DC output voltage within a set range by controlling a discharge path of the flying capacitor Cf to ground to control the amount of charge transferred from the flying capacitor Cf to the energy storage capacitor Cs during a plurality of AC changing cycles.

Further, in a case that the AC input voltage Vac is a negative voltage, the rectifier 102 couples the flying capacitor Cf between two ends of the AC power supply 101, and charges the flying capacitor Cf by the AC power supply 101. In a case that the AC input voltage Vac is a positive voltage, the rectifier 102 couples the flying capacitor Cf and the energy storage capacitor Cs in series between two ends of the AC power supply 101, and charges the energy storage capacitor Cs through the flying capacitor Cf.

Further, the rectifier 102 controls the discharge path of the flying capacitor to ground according to a charging voltage level on the energy storage capacitor Cs. For example, if a voltage on the energy storage capacitor Cs is low, the rectifier 102 turns off the discharge path of the flying capacitor Cf to ground in the case that the AC input voltage Vac is the positive voltage, and the AC input voltage Vac charges the energy storage capacitor Cs through the flying capacitor Cf and the transfer path: if the voltage on the energy storage capacitor Cs exceeds a desired voltage, the rectifier 102 turns off the discharge path of the flying capacitor Cf to ground, so that the flying capacitor Cf discharges to ground or alternating current reversely charges the flying capacitor Cf through the discharge path, thereby achieving a function of stabilizing the DC output voltage Vout in the set range.

Further, the rectifier 102 includes a switching element 121, a rectifying element 122 and a comparator 123. The switching element 121 is connected between the second end of the flying capacitor Cf and the second end of the AC power supply 101. The rectifying element 122 is connected between the second end of the flying capacitor Cf and the first end of the energy storage capacitor Cs. The comparator 123 is configured to control the switching element 121 to be on and off according to the voltage on the energy storage capacitor Cs.

Further, the switching element 121 may include an NMOS transistor Q1 (an N-channel metal oxide semiconductor (NMOS) field effect transistor (FET)). In the case the AC input voltage Vac is the negative voltage, the AC power supply 101 charges the flying capacitor Cf through a body diode of the NMOS transistor Q1. For example, if the NMOS transistor Q1 is in an on state at this time, the AC power supply 101 charges the flying capacitor Cf directly through the NMOS transistor Q1. The rectifying element 122 includes, for example, a diode D1. In the case that the AC input voltage Vac is the positive voltage and the NMOS transistor Q1 is in an off state, the flying capacitor Cf transfers energy to the energy storage capacitor Cs through the diode D1. If the voltage on the energy storage capacitor Cs exceeds the desired voltage, the NMOS transistor Q1 is turned on, the flying capacitor Cf discharges to ground GND or the AC power supply 101 reversely charges the flying capacitor Cf. It can be understood that although the switching element 101 in the present embodiment provides both of the charge path and the discharge path of the flying capacitor Cf, whether the flying capacitor Cf is charged or discharged (also referred to as reversely charged) mainly depends on whether the AC input voltage Vac changes in a positive direction or a negative direction.

Further, the comparator 123 has a voltage hysteresis function, and may include a hysteresis comparator having one input terminal coupled to the first end of the energy storage capacitor Cs and the other terminal coupled to a reference voltage VREF and a hysteresis voltage Vhys. The comparator 123 turns on the NMOS transistor Q1 when the voltage on the energy storage capacitor Cs is higher than the reference voltage VREF to stop the charging on the energy storage capacitor Cs, and turns off the NMOS transistor Q1 when the voltage on the energy storage capacitor Cs is lower than VREF-Vhys to allow the charging on the energy storage capacitor Cs, so that a function of stabilizing the DC output voltage Vout within the set range is achieved.

Further, in specific applications, the energy storage capacitor Cs is used to maintain the power supply to the load when the NMOS transistor Q1 is in the on state, so the energy storage capacitor Cs needs to have a large capacitance. Assuming that the energy storage capacitor Cs has a capacitance much larger than the capacitance of the flying capacitor Cf, the voltage on the energy storage capacitor Cs changes little in each charging cycle, and the voltage on the energy storage capacitor Cs is much lower than a peak-to-peak voltage of alternating current, the amount of charge transferred by the flying capacitor Cf in each AC changing cycle can be used to estimate the power that can be transmitted. Denote a cycle time of alternating current as T, and the peak-to-peak voltage of alternating current as Vpp, an output power P=2×Vpp×Vout×Cf/T. For the AC input voltage Vac of 220V at 50 Hz, when the output voltage is 30V, the transfer capacitor Cf needs to have a capacity of 0.28 μF for providing an output power 1 W, so the flying capacitor Cf does not need to be implemented by a high voltage device, which can greatly reduce circuit cost.

In addition, the loss of the power conversion circuit 100 in the charging and discharging process of the present embodiment is determined only by the loss caused by path resistance. For example, a current passing through the charging and discharge path under the above conditions is about 30 mA, and the loss can be very low as long as an on-resistance of the NMOS transistor Q1 is small. In addition, when the NMOS transistor Q1 is in the on state, the transfer capacitor Cf is equivalent to a capacitive load, and its power consumption is only determined by its equivalent series resistance, thus a condition of low power consumption can also be satisfied.

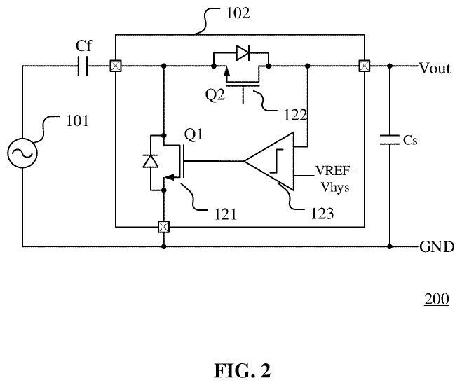

FIG. 2 shows a schematic circuit diagram of a power conversion circuit according to a second embodiment of the present disclosure. Compared with the power conversion circuit 100 of the first embodiment, the power conversion circuit 200 of the present embodiment is a synchronous rectifier regulator, wherein the rectifying element 122 includes an NMOS transistor Q2, and the NMOS transistor Q2 and the NMOS transistor Q1 are turned on non-simultaneously. By using the NMOS transistor Q2 with extremely low on-resistance instead of the rectifier diode D1, the loss in the rectification process is reduced, thereby greatly improving the efficiency of the power conversion circuit.

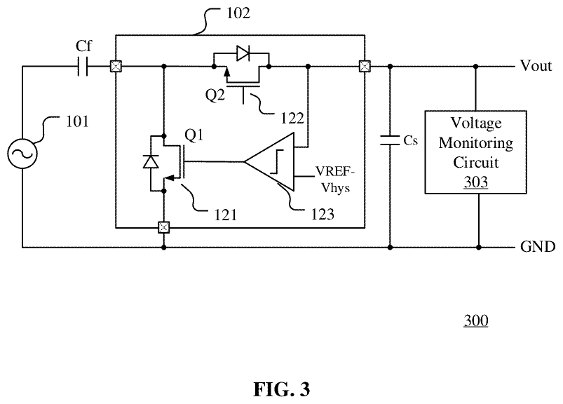

FIG. 3 shows a schematic circuit diagram of a power conversion circuit according to a third embodiment of the present disclosure. In other embodiments, for applications of battery charging or directly driving circuit or resistive load, the power conversion circuit further provides a voltage monitoring circuit at an output terminal for outputting the DC output voltage Vout to ensure that a voltage level maintains within a predetermined range. As shown in FIG. 3, the power conversion circuit 300 further includes the voltage monitoring circuit 303 which may include but is not limited to: an overvoltage protection circuit, an under-voltage protection circuit or some combination of the two: a regulator; a DC-DC converter; or other circuits that can ensure that the voltage level maintains within the predetermined range.

Further, the DC-DC converter may be achieved by a variety of topologies, which include but not limited to Buck-type, Boost-type, Buck-Boost-type, non-inverting Buck-Boost-type and other topologies. Furthermore, the DC-DC converter may also be achieved by forward-type or flyback-type topology, and a purpose of isolation and voltage stabilization may be realized by adding secondary windings.

According to another aspect of the embodiment of the present disclosure, there is provided a power conversion method using a charge pump structure to achieve rectification and achieving stable control of the output voltage by controlling the discharge path to control a number of times to transfer charge in the charge pump. The power conversion method includes following steps: setting a flying capacitor Cf and an energy storage capacitor Cs: turning on a charge path through which the flying capacitor Cf is charged by the AC input voltage Vac or a transfer path from the flying capacitor Cf to the energy storage capacitor Cs selectively according to a direction of the AC input voltage Vac, so as to provide the DC output voltage Vout across ends of the energy storage capacitor Cs: and stabilizing the DC output voltage Vout within a set range by controlling a discharge path of the flying capacitor Cf to ground in a charging process of the energy storage capacitor Cs.

Further, in a case that the AC input voltage Vac is a negative voltage, the flying capacitor Cf is coupled between two ends of the AC power supply 101, and the flying capacitor Cf is charged by the AC power supply 101: in a case that the AC input voltage Vac is a positive voltage, the flying capacitor Cf and the energy storage capacitor Cs is coupled in series between two ends of the AC power supply 101, and the energy storage capacitor Cs is charged by the flying capacitor Cf. If a voltage on the energy storage capacitor Cs exceeds a desired voltage, the discharge path of the flying capacitor Cf is turned on, and the flying capacitor Cf discharges to ground GND or the AC power supply reversely charges the flying capacitor Cf.

In summary, the present disclosure provides a power conversion circuit using the charge pump to achieve rectification and including the flying capacitor, the energy storage capacitor, and the rectifier. The rectifier turns on the charge path through which the flying capacitor is charged by the AC input voltage or the transfer path from the flying capacitor to the energy storage capacitor selectively according to the direction of the AC input voltage, so as to provide the DC output voltage across the ends of the energy storage capacitor, and a number of times to transfer charge in the charge pump is controlled by controlling the discharge path to achieve stable control of the output voltage. Compared with conventional AC-DC converters, no high-voltage device and other rectifying circuit is needed in the power conversion circuit of the present disclosure, so as to reduce structure complexity and cost of the circuit greatly. Further, the power conversion circuit of the present disclosure has an extremely low loss, so that the power conversion circuit of the present disclosure is significantly superior to conventional AC-DC converters, both in terms of hardware cost and usage cost.

Further, the power conversion circuit of the present disclosure greatly reduces the power consumption and cost of the auxiliary power supply, and the auxiliary power supply with high efficiency and low power provides the possibility of using sensing startup devices in a large number of applications.

It should be noted that relational terms such as first and second etc. are used herein only to distinguish one entity or operation from another and do not necessarily require or imply any such actual relationship or order between these entities or operations. Moreover, the terms “including”, “including” or any other variation thereof are intended to encompass non-exclusive inclusion, so that a process, method, article or equipment that includes a set of elements includes not only those elements but also other elements that are not explicitly listed or are inherent to such a process, method, article or equipment. In the absence of more restrictions, the statement “includes a . . . ” A defined element does not preclude the existence of another identical element in the process, method, article or equipment that includes the said element.

Embodiments in accordance with the present disclosure such as described above are not exhaustively described in all details nor are the disclosure limited to the specific embodiments described. Obviously, according to the above description, many modifications and changes can be made. These embodiments are selected and specifically described in this specification to better explain the principles and practical applications of the present disclosure, so that those skilled in the art can make good use of the present disclosure and modifications based on the present disclosure. The present disclosure is limited only by the claims and their full scope and equivalents.

1. A power conversion circuit used for converting an AC input voltage to a DC output voltage, comprising:
a flying capacitor;
an energy storage capacitor; and
a rectifier configured to turn on a charge path through which the flying capacitor is charged by the AC input voltage or a transfer path from the flying capacitor to the energy storage capacitor selectively according to a direction of the AC input voltage, so as to provide the DC output voltage across ends of the energy storage capacitor,
wherein the rectifier is further configured to stabilize the DC output voltage within a set range by controlling a discharge path of the flying capacitor to ground.

2. The power conversion circuit according to claim 1, wherein
in a case that the AC input voltage is a negative voltage, the rectifier couples the flying capacitor between two ends of an AC power supply and charges the flying capacitor by the AC power supply,
in a case that the AC input voltage is a positive voltage, the rectifier couples the flying capacitor and the energy storage capacitor in series between two ends of the AC power supply and charges the energy storage capacitor by the flying capacitor.

3. The power conversion circuit according to claim 2, wherein the rectifier is configured to control the discharge path of the flying capacitor to ground according to a charging voltage level of the energy storage capacitor.

4. The power conversion circuit according to claim 3, wherein the rectifier comprises:
a rectifying element connected between the flying capacitor and the energy storage capacitor; and
a switching element connected between the flying capacitor and a second end of said AC power supply,
wherein in a case that the AC input voltage is the positive voltage and the switching element is in an off state, the flying capacitor transfers energy to the energy storage capacitor,
in a case that the AC input voltage is the positive voltage and the switching element is in an on state, the flying capacitor discharges to ground through the switching element.

5. (canceled)

6. The power conversion circuit according to claim 45, wherein the rectifier further comprises:
a comparator, configured to control the switching element to be on and off according to a voltage on the energy storage capacitor.

7. The power conversion circuit according to claim 6, wherein the comparator is a hysteresis comparator.

8. The power conversion circuit according to claim 4, wherein the switching element comprises a field effect transistor, and the rectifying element comprises a diode or a field effect transistor.

9. (canceled)

10. The power conversion circuit according to claim 1, further comprising a voltage monitoring circuit, wherein the voltage monitoring circuit is configured to maintain the DC output voltage within a predetermined range.

11. The power conversion circuit according to claim 10, wherein the voltage monitoring circuit comprises:
one or a combination of some of an overvoltage protection circuit, an under-voltage protection circuit, a voltage regulator and a DC-DC converter.

12. The power conversion circuit according to claim 11, wherein the DC-DC converter comprises a topology selected form a group consisting of Buck-type, Boost-type, Buck-Boost-type, non-inverting Buck-Boost-type, forward-type, flyback-type topologies.

13. A power conversion method used for converting an AC input voltage to a DC output voltage, comprising:
setting a flying capacitor and an energy storage capacitor;
turning on a charge path through which the flying capacitor is charged by the AC input voltage or a transfer path from the flying capacitor to the energy storage capacitor selectively according to a direction of the AC input voltage, so as to provide the DC output voltage across ends of the energy storage capacitor; and
stabilizing the DC output voltage within a set range by controlling a discharge path of the flying capacitor to ground.

14. The power conversion method according to claim 13, wherein turning on a charge path through which the flying capacitor is charged by the AC input voltage or a transfer path from the flying capacitor to the energy storage capacitor selectively according to a direction of the AC input voltage comprises:
coupling the flying capacitor between two ends of an AC power supply and charging the flying capacitor by the AC power supply in a case that the AC input voltage is a negative voltage,
coupling the flying capacitor and the energy storage capacitor in series between two ends of the AC power supply and charging the energy storage capacitor by the flying capacitor in a case that the AC input voltage is a positive voltage.

15. The power conversion method according to claim 14, wherein stabilizing the DC output voltage within a set range by controlling a discharge path of the flying capacitor to ground comprises:
controlling the discharge path of the flying capacitor to ground according to a charging voltage level of the energy storage capacitor.

16. The power conversion method according to claim 15, further comprising:
arranging a rectifying element between the flying capacitor and the energy storage capacitor; and
arranging a switching element between the flying capacitor and a second end of said AC power supply;
wherein, in a case that the AC input voltage is the positivenegative voltage and the switching element is in an off state, the flying capacitor transfers energy to the energy storage capacitor,
in a case that the AC input voltage is the positive voltage and the switching element is in an on state, the flying capacitor discharges to ground through the switching element.

17. The power conversion method according to claim 16, wherein controlling the discharge path of the flying capacitor to ground according to a charging voltage level of the energy storage capacitor comprises:
setting a comparator configured to control the switching element to be on and off according to a voltage on the energy storage capacitor.

18. The power conversion method according to claim 17, wherein the comparator is a hysteresis comparator.

19. The power conversion method according to claim 16, wherein the switching element comprises a field effect transistor, and the rectifying element comprises a diode or a field effect transistor.

20. (canceled)

21. The power conversion method according to claim 13, further comprising:
setting a voltage monitoring circuit, wherein the voltage monitoring circuit is configured to maintain the DC output voltage within a predetermined range.

22. The power conversion method according to claim 21, wherein the voltage monitoring circuit comprises:
one or a combination of some of an overvoltage protection circuit, an under-voltage protection circuit, a voltage regulator and a DC-DC converter.

23. The power conversion method according to claim 22, wherein the DC-DC converter comprises a topology selected form a group consisting of Buck-type, Boost-type, Buck-Boost-type, non-inverting Buck-Boost-type, forward-type, flyback-type topologies.
